(19) United States
(12) Patent Application Publication
(10) Pub. No.: US 2015/0095084 A1
(43) Pub. Date: Apr. 2, 2015

(54) METHODS AND SYSTEMS FOR CONNECTING EMAIL SERVICE PROVIDERS TO CROWDSOURCING COMMUNITIES

(71) Applicants: Matthew Cordasco, Corte Madera, CA (US); Kirk Franzen, Corte Madera, CA (US)

(72) Inventors: Matthew Cordasco, Corte Madera, CA (US); Kirk Franzen, Corte Madera, CA (US)

(21) Appl. No.: 14/567,244

(22) Filed: Dec. 11, 2014

Related U.S. Application Data
(63) Continuation-in-part of application No. 14/097,236, filed on Dec. 4, 2013.
(60) Provisional application No. 61/733,508, filed on Dec. 5, 2012.

(51) Int. Cl. G06Q 10/06; G06Q 50/00; G06Q 10/10

(52) U.S. Cl. CPC G06Q 10/063114; G06Q 10/107; G06Q 50/01
USPC 705/7.15

(57) ABSTRACT

Provided are computer implemented methods and systems for crowdsourcing an email testing task. A method for crowdsourcing an email testing task may include receiving the email testing task from a customer. The email testing task may include at least an email content. The method may include providing the email testing task to a crowdsourcing community. Upon performing the email testing task by the crowdsourcing community, results of performing the email testing task may be received from the crowdsourcing community. The method may further include providing the results of performing the email testing task to the customer.

### RELATED APPLICATIONS

This application is a Continuation-In-Part of U.S. patent application Ser. No. 14/097,236, filed on Dec. 4, 2013, titled “METHODS AND SYSTEMS FOR CONNECTING THIRD PARTY APPLICATIONS TO CROWDSOURCING COMMUNITIES,” which is incorporated herein by reference in its entirety for all purposes.

### FIELD

This disclosure relates generally to data processing and, more specifically, to connecting email service providers to crowdsourcing communities.

### BACKGROUND

Crowdsourcing has been increasing in popularity and many tasks are now being outsourced using crowdsourcing approaches. Crowdsourcing typically involves distributed problem-solving and production models. In a typical crowdsourcing scenario, a crowdsourcer may broadcast a problem to a group of solvers in the form of an open call for solutions. The solvers, also referred to as the “crowd,” can submit various solutions to the problem. Contributors to the solution, in some cases, are compensated monetarily or otherwise. In some cases, the only rewards include kudos or intellectual satisfaction. Crowdsourcing may produce solutions submitted by amateurs or volunteers working in their spare time, or from experts or small businesses, which were unknown to the crowdsourcer.

Motivations of a crowdsourcer include gathering a large number of solutions or information at low cost and having a problem solved quickly. Users may be motivated to contribute by engaging in the crowdsourcing as a social activity or by financial gain. Even though crowdsourcing is in wide use, there is still a need for tools to facilitate crowdsourcing.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer implemented methods and systems for crowdsourcing an email testing task. A computer-implemented method for crowdsourcing an email testing task may include receiving the email testing task from a customer. The method may also include providing the email testing task to a crowdsourcing community. Upon performing the email testing task by the crowdsourcing community, results of performing the email testing task may be received from the crowdsourcing community. The method may further include providing the results of performing the email testing task to the customer.

The system for crowdsourcing an email testing task may include a processor and a database communicatively coupled to the processor and configured to store at least the email testing task, the email content, and credentials associated with the crowdsourcing community. The processor may be operable to receive the email testing task from a customer. The email testing task may include at least an email content. The processor may further be operable to provide the email testing task to a crowdsourcing community. The processor may be operable to receive results of performing the email testing task from the crowdsourcing community. Upon receiving the results performing the email testing task, the processor may be operable to provide the results of performing the email testing task to the customer.

In further exemplary embodiments, modules, subsystems, or devices can be adapted to perform the recited steps. Other features and exemplary embodiments are described below.

### BRIEF DESCRIPTION OF THE DRAWINGS

Embodiments are illustrated by way of example and not limited to the figures of the accompanying drawings, in which like references indicate similar elements and in which:

FIG. 1 is a block diagram illustrating an example environment within which methods and systems for crowdsourcing an email testing task can be implemented.

FIG. 2 shows a detailed block diagram of the system for crowdsourcing an email testing task, in accordance with an example embodiment.

FIG. 3 is a flow chart illustrating a method for crowdsourcing an email testing task, in accordance with some example embodiments.

FIG. 4 shows an example interaction of an email service provider and a system for crowdsourcing an email testing task, in accordance with some example embodiments.

FIG. 5 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail to not unnecessarily obscure the described concepts. While some concepts will be described in conjunction with the specific embodiments, it will be understood that these embodiments are not intended to be limiting.

The following detailed description refers to methods and systems for crowdsourcing email testing tasks. A user, also referred to as a customer, can utilize a crowdsourced marketplace to test emails the user is planning to send. The crowdsourced marketplace may combine a number of crowdsourcing communities. A crowdsourcing community may comprise a pool of contractors able to perform testing of emails. Contractors from any location can register in the system for crowdsourcing an email testing task. The contractors can use any language supported by the system for crowdsourcing an email testing task.

Crowdsourcing is used to source work to a number of contractors in a form of an open call. Each of the contractors can work on a specific task within a project. The contractors are typically members of an online crowdsourcing community. The benefits of crowdsourcing include lower expenses compared to the expenses associated with hiring a professional, a large number of alternative contractors to choose from, shorter execution terms due to distribution of the tasks to a large group of people, and so forth.

The crowdsourcing community members can register in the crowdsourcing platform to offer their services and search for projects. The customer may connect to a system for crowdsourcing an email testing task. For example, the customer may connect to the system for crowdsourcing an email testing task using a user device, such as a personal computer (PC) or a smart phone. Upon connecting to the system for crowdsourcing an email testing task, the customer may provide the email to the system for crowdsourcing an email testing task for testing using a crowdsourcing platform. Alternatively, the customer may connect to the system for crowdsourcing an email testing task via an email service provider (ESP) associated with the customer. The ESP may include any platform, service, or software application that facilitates sending of emails. The ESP may receive an email from the customer and provide the email to the system for crowdsourcing an email testing task and, therefore, to the crowdsourcing platform for testing. Alternatively, the email may be provided to the system for crowdsourcing an email testing task from other sources, such as a third-party application associated with the customer. The email may be provided in a form of an email testing task. The email testing task may contain a task description, an email content, email enclosures, and so forth. In the task description, the customer may request to review email content, edit email content, validate email content, provide feedback for email content, and so forth.

To facilitate performance of the email testing task, a crowd connector can be embedded into the ESP or a web page associated with the ESP. The crowd connector may enable communications between the crowdsourcing platform and the ESP. The crowd connector can provide control elements (for example, an additional menu to allow selecting email content related to the crowdsourcing email testing task and transmitting the email content to the system for crowdsourcing an email testing task). The email testing task provided by the customer, the ESP, or the third-party application associated with the customer to the crowdsourcing platform may be received by the system for crowdsourcing an email testing task. The system for crowdsourcing an email testing task can advertise the email testing task to the crowdsourcing community via the crowdsourcing platform. Potential contractors can bid or otherwise declare their interest in the email testing task through the crowdsourcing platform. Profiles of the potential contractors can be evaluated by the system for crowdsourcing an email testing task and some of the potential contractors can be selected to perform the email testing task. Contractors may submit results of their work on the email testing task though the crowdsourcing platform. In some embodiments, contractors may execute the email testing task using the ESP. Connection of the contractors to the ESP is enabled through the crowd connector.

In some embodiments, the system for crowdsourcing an email testing task can monitor email testing task performance and generate reports representing the email testing task progress. In some embodiments, the system for crowdsourcing an email testing task can manage payment across crowdsourcing platforms.

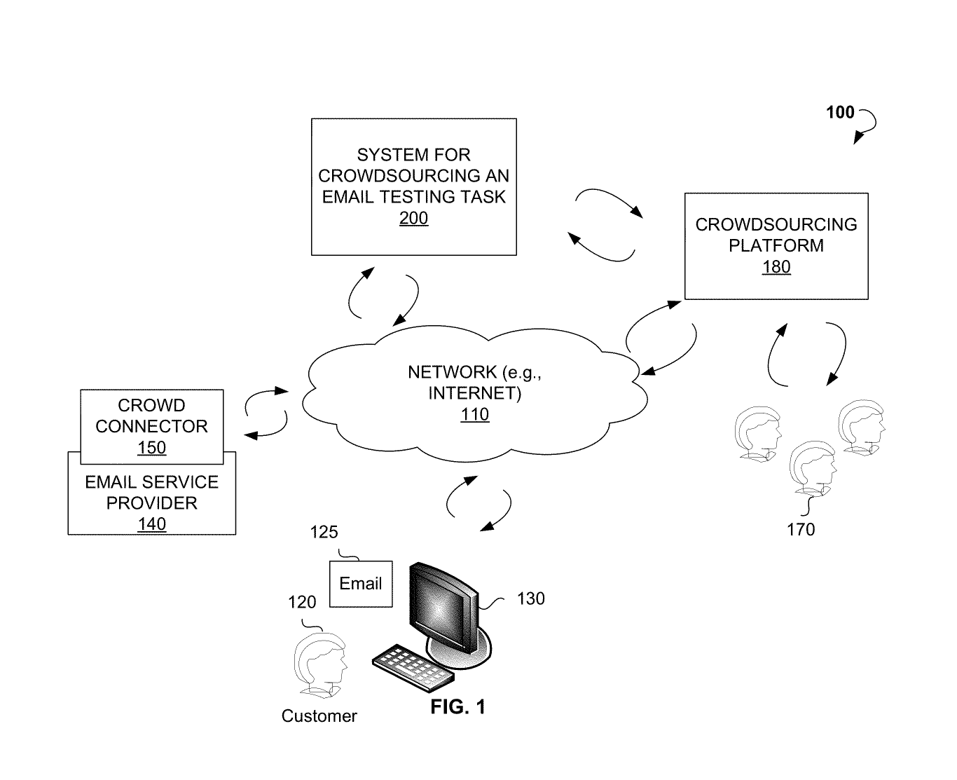

FIG. 1 is a block diagram showing an example environment 100 within which a method and system for crowdsourcing an email testing task can be implemented. The example environment 100 may include a crowdsourcer shown as a customer 120. The customer may interact with an ESP 140. The ESP 140 can include a platform, a service, or a software application that facilitates sending of emails and is used by the customer 120 to send emails. For example, the ESP can include Gmail, Outlook, Vertical Response, GetResponse, Constant Contact, MailChimp, Customer.io, ToutApp, SendGrid, and so forth.

The customer 120 may interact with a system 200 for crowdsourcing an email testing task via a user device 130. The user device 130 may include a mobile telephone, a PC, a laptop, a smart phone, a tablet PC, and so forth. The customer 120 can send an email testing tasks to the system 200 for crowdsourcing an email testing task using the user device 130. In an example embodiment, an email testing task includes an email 125 sent by the customer 120.

In an example embodiment, the customer 120 may interact with the ESP 140 via a user device 130. The customer 120, in some example embodiments, is a person interacting with the ESP 140 via the user device 130. To facilitate crowdsourcing, a crowd connector 150 may be built into the ESP 140. The crowd connector 150, in some embodiments, is a connector code (e.g., JavaScript) running on the web page, such as the web page associated with the ESP 140. The crowd connector 150 can take a form of an extension, add-in, or plug-in (e.g., Bookmarklet) and is tightly integrated with the ESP 140.

The crowd connector 150 may provide additional control elements displayed in an interface associated with the ESP 140. Using the additional control elements, the customer 120 can post email testing tasks and control crowdsourcing operations. The crowd connector 150 can communicate with the system 200 for crowdsourcing an email testing task to transmit the email testing task containing the email 125 from the customer 120 to a creative crowd 170 and submissions from creative crowd 170 back to the customer 120.

In an example embodiment, the email testing task containing the email 125 may be sent using a third-party application (not shown) associated with the customer 120.

The system 200 can receive the email testing task from the customer 120, the crowd connector 150, or the third-party application associated with the customer 120 and post the email testing task to a crowdsourcing platform 180 to advertise to the creative crowd 170. In an example embodiment, the crowdsourcing platform 180 is an integral part of the system 200. The creative crowd 170, also referred to as contractors, can include any number of independent individuals, agencies, or entities capable of receiving a request for an email testing task, bidding on the email testing task, and providing work results for consideration. The creative crowd 170 can perform email testing tasks and submit the results to the crowdsourcing platform 180 and/or to the system 200. Additionally, submissions can be transmitted to the ESP 140. Communications between the customers 120, the crowd connector 150, the system 200, the third-party application associated with the customer 120, and crowdsourcing platform 180 can be via a network 110.

The network 110 may include the Internet or any other network capable of communicating data between devices. Suitable networks can include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

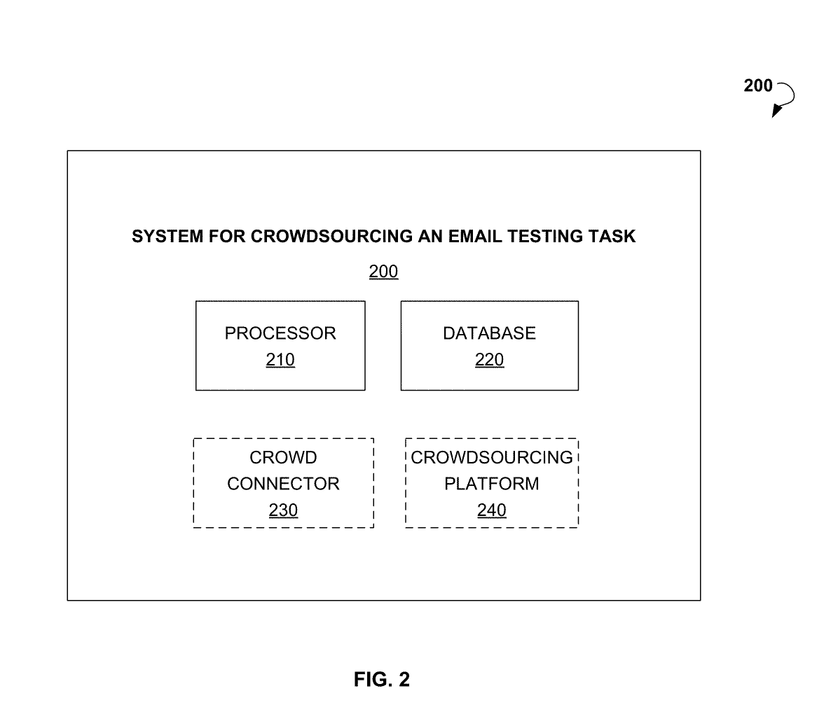

FIG. 2 shows a detailed block diagram of the system 200 for crowdsourcing an email testing task, in accordance with an example embodiment. The system 200 may include a processor 210, a database 220, and, optionally, a crowd connector 230 and a crowdsourcing platform 240. The processor 210 can include a programmable processor, such as a microcontroller, central processing unit (CPU), and so forth. In other embodiments, the processor 210 can include an application-specific integrated circuit (ASIC) or programmable logic array (PLA), such as a field programmable gate array (FPGA), designed to implement the functions performed by the system 200.

The processor 210 can be operable to receive an email testing task from a customer. The email testing task may include at least an email content. The email testing task may be received from the customer using a user device associated with the customer, an ESP, and a third-party application associated with the customer. The processor 210 may be operable to provide the email testing task to a crowdsourcing community. Crowdsourcing community members, i.e. contractors, can be registered with the crowdsourcing platform 240. In an example embodiment, the email testing task further includes at least a task description. The email testing task may include one or more of the following: a typographical error checking task, a grammar checking task, a broken link checking task, a broken image checking task, an incorrect information checking task, a display checking task related to display issues across different devices, an opinion and feedback task, and so forth.

In an example embodiment, the processor 210 may be operable to advertise the email testing task to the crowdsourcing community. Upon advertising, the processor 210 may be operable to assign the email testing task to a contractor associated with the crowdsourcing community for performing the email testing task. The email testing task can be assigned to the contractor based on predetermined criteria. The predetermined criteria can be specified by the customer and can include a desired experience level, acceptable payment options, a contractor rating, a minimum number of successfully performed tasks, and so forth. In an example embodiment, the email testing task may be assigned to the contractor based on self-selection of the contractor. The self-selection of the contractor may include accepting the advertised email testing task by the contractor. Furthermore, data concerning the one or more contractors selected by the system 200 can be provided to the customer. The customer can make a final choice, reject certain contractors, provide a command to repeat the selection process, modify selection criteria, and so forth.

The providing the email testing task to the crowdsourcing community may include sending the email content associated with the email testing task to the crowdsourcing community. In an example embodiment, the providing of the email testing task to the crowdsourcing community may include providing the email testing task to the contractor.

The processor 210 may be operable to receive results of performing the email testing task from the crowdsourcing community. In an example embodiment, the contractor may submit results of performing the email testing task.

The processor 210 may be operable to provide the results of performing the email testing task to the customer. The results of performing the email testing task may be provided to the customer via one or more of a web-based dashboard, a mobile application, an email, an application programming interface, an export to a predetermined format, and so forth.

In a further example embodiment, the ESP may include a crowd connector. Providing the email testing task to the crowdsourcing community may include connecting a contractor to the ESP via the crowd connector. In example embodiments, the crowd connector 230 can connect the selected contractor to the ESP to enable the contractor to perform the email testing task remotely. The crowd connector may be embedded in the ESP as one or more of the following: a native application, i.e. an application being natively embedded in the ESP, a browser extension, a code snippet, an application plug-in, an application add-in, a tag management system, an embedding referential link, and so forth. In an example embodiment, the crowd connector provides control elements in an application accommodating the crowd connector and associated with the ESP. For example, the crowd connector can insert menus or buttons, or produce an overlay or insert menus on top of the application associated with the ESP. In example embodiments, the crowd connector 230 embedded in the ESP may be operable to send the email testing task to the crowdsourcing community.

Thus, the crowd connector 230 may include a module enabling connection of the system 200 and the ESP associated with the customer. The crowd connector 230 may be integrated into the ESP with or without consent of the customer. Integration can be implemented by various methods. For example, the crowd connector 230 can be built into the ESP as an application add-in, a browser plug-in (e.g., a Bookmarklet instantiated JavaScript code), a tag management system, embedded referential links to the system 200, dynamic loading of a library associated with the system 200, and so forth.

In a further example embodiment, the processor 210 may be operable to receive a confirmation of completion of the email testing task by a contractor from the customer. Based on the confirmation, the processor 210 may be operable to manage payments associated with the email testing task.

The database 220 can store the email testing task as well as accounts associated with the customer and the crowdsourcing platform 240, crowdsourcer preferences and predefined criteria, selected contractors and submitted results of their work, credentials associated with the crowdsourcing community, and other data. In some embodiments, the database 220 stores data associated with membership of crowdsourcers, A/B testing vendors, operators, and creative crowds. Additionally, the database 220 can store data associated with terms, finances, fulfillment, and assets related to various transactions. Moreover, the system 200 can keep track of hours, billing, commissions, and royalties.

The system 200 can be configured to keep track of various resources associated with proposed email testing tasks, final results, and so forth. For example, the system 200 can host documents, spreadsheets, presentations, HTML files, CSS files, JavaScript code, images, or other resources associated with the email testing task. In certain embodiments, the technology may be implemented with core servers or via a global Content Delivery Network (such as Akamai or CloudFront).

In example embodiments, the system 200 may provide a standardized environment for requests, submissions, and billing to the customer, as well as for user registration, payments and transactions, management of crowdsourcing community, creation and management of tasks, and so forth. For example, the crowdsourcing platform 240 may require advance payment and may bill the crowdsourcer upon delivery of the completed task. Furthermore, the crowdsourcing platform 240 may allow running a contest or may provide only a flat fee option. The system 200 allows the customer to define preferences with respect to billing, payments, terms, qualifications of contractors, and so forth. The system selects the contractors and/or options according to the preferences selected by the customer.

The system 200 enables any professional and billing relationships, including but not limited to the following: free, volunteer, work for hire, work for trade, direct hiring, fixed bid contract, hourly pricing, page view pricing, results-based pricing, performance based pricing, auctions, or contest-based pricing.

In an example embodiment, the system 200 may be a software-as-a-service platform written in Ruby on Rails with a client-side code including JavaScript and HTML.

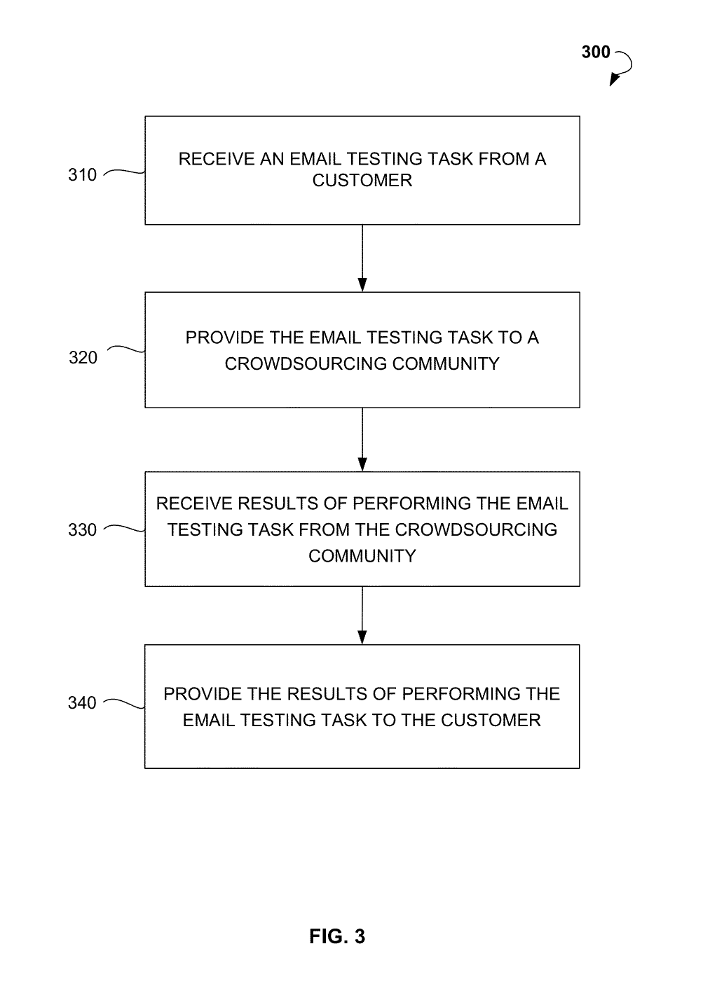

FIG. 3 is a flow chart illustrating a method 300 for crowdsourcing an email testing task, in accordance with some example embodiments. The method 300 may be performed by logic that may comprise hardware (e.g., dedicated logic, programmable logic, and microcode), software (such as software run on a general-purpose computer system or a dedicated machine), or a combination of both. In one example embodiment, the processing logic resides at the system 200 for crowdsourcing an email testing task, and the various elements of the system 200 can perform the method 300. It will be appreciated by one of ordinary skill that examples of the foregoing modules may be virtual, and instructions said to be executed by a module may, in fact, be retrieved and executed by software. Although various elements may be configured to perform some or all of the various operations described herein, fewer or more elements may be provided and still fall within the scope of various embodiments.

As shown in FIG. 3, the method 300 may commence at operation 310 with receiving an email testing task from a customer. The email testing task may include at least an email content. In an example embodiment, the email testing task is received from the customer using one or more of the following: a user device associated with the customer, an ESP, a third-party application associated with the customer, and so forth. The email testing task may include one or more of the following: a typographical error checking task, a grammar checking task, a broken link checking task, a broken image checking task, an incorrect information checking task, a display checking task, an opinion and feedback task, and so forth. The email testing task may further include task description, data on timing, payments, and so forth. In some embodiments, the customer can modify or provide additional information related to the email testing task (e.g., description of the task, timing data, and payment data).

The method 300 may continue with providing the email testing task to a crowdsourcing community at operation 320. In an example embodiment, providing the email testing task to the crowdsourcing community includes sending the email content associated with the email testing task to the crowdsourcing community.

In an example embodiment, the email testing task may be performed by one or more contractors of the crowdsourcing community. More specifically, a first contractor may find and remove an error in the email content. The first contractor may flag the email testing task to indicate that the error was removed. One or more further contractors may review the flagged email testing task to validate removal of the error. The one or more further contractors may additionally flag the email testing task to indicate that the testing of the email content by the first contractor is validated.

In an example embodiment, the ESP optionally includes a crowd connector. The crowd connector may be embedded in the ESP as one or more of the following: a native application, a browser extension, a mobile application, a code snippet, an application plug-in, an application add-in, a tag management system, an embedding referential link, and so forth. The providing of the email testing task to the crowdsourcing community may include connecting a contractor to the ESP via the crowd connector. In an example embodiment, the email testing task may be performed by the contractor remotely.

Optionally, the method 300 may include advertising the email testing task to the crowdsourcing community. Upon advertising, the email testing task may be assigned to a contractor associated with the crowdsourcing community based on predetermined criteria. In some embodiments, the email testing task may be assigned to the contractor based on self-selection of the contractor. In an example embodiment, the providing of the email testing task to the crowdsourcing community may include providing the email testing task to the contractor. In an example embodiment, upon completion of the email testing task, the contractor may submit results of performing the email testing task.

At operation 330, results of performing the email testing task may be received from the crowdsourcing community. The method 300 may continue with providing the results of performing the email testing task to the customer at operation 340. The results of performing the email testing task may be provided to the customer via one or more of a web-based dashboard, a mobile application, an email, an application programming interface, an export to a predetermined format, and so forth.

In some embodiments, method 300 may include classifying the email testing task. For example, the email testing task may be classified as a typographical error checking task, a grammar checking task, a broken link checking task, a broken image checking task, an incorrect information checking task, a display checking task, an opinion and feedback task, and so forth. Based on the classification, the contractor matching the task can be identified. The classified task may be advertised to the contractor identified as matching the task class.

In an example embodiment, performing of the email testing task may be automated or hidden from the customer. For example, the crowdsourced email testing task, such as the crowdsourced review of the email content, may be performed after the customer selects a “send” option upon creating an email. The results of the review of the email content may be sent to the customer. Additionally, the results of performing the email testing task may be used in different ways, including for presenting to the customer, refining machine algorithms, or creating “best practices” for other customers.

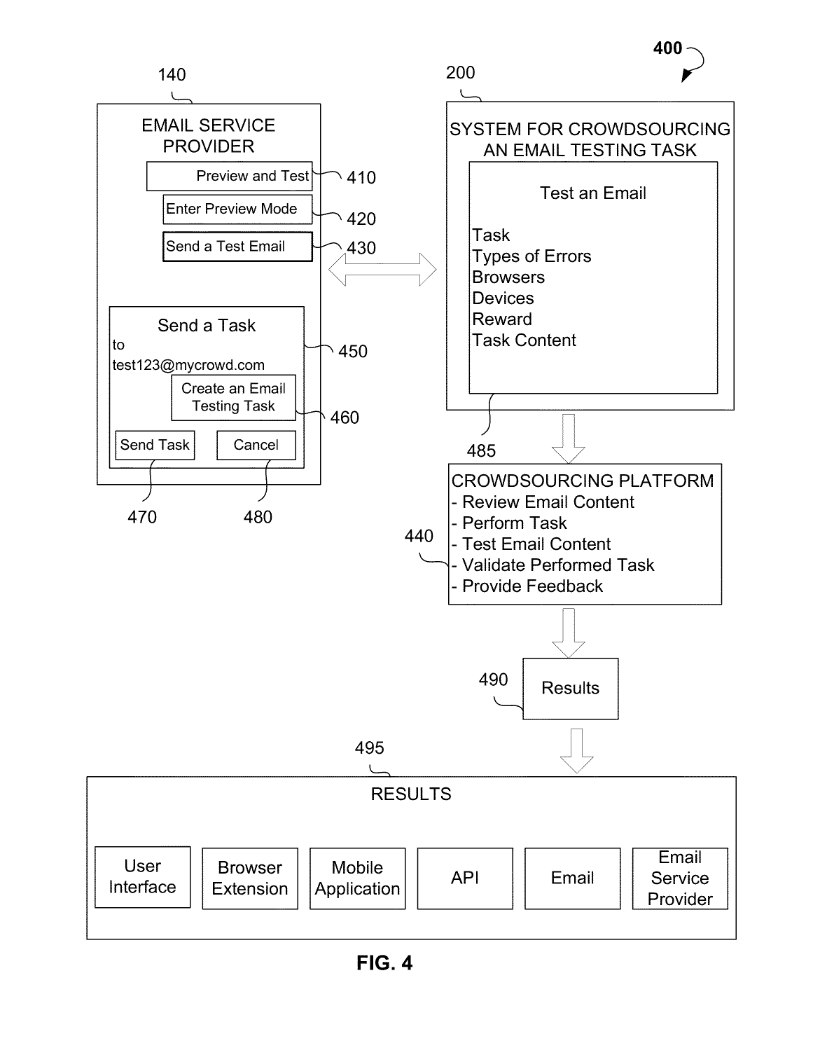

FIG. 4 shows an example interaction 400 of an ESP and a system for crowdsourcing an email testing task. A customer may connect to the ESP 140. The ESP 140 may include software, an application, or a platform operable to send emails of the customer. The customer may create a new email testing task for the purpose of verifying the content, logic, formatting and the like. The customer may select field 410 to preview and test the email, i.e. to create an email testing task. The customer may have, for example, an option 420 for entering a preview mode and an option 430 for sending a test email. Upon selection of the option 430, a field 450 may be displayed to the customer. Using the field 450, the customer may designate a destination email address to which the email may be sent for testing. The customer may finalize creation of the email testing task may clicking a button 460. The customer may send the email testing task to the system 200 for crowdsourcing an email testing task by clicking a button 470, or the customer may cancel creation of the email testing task by clicking a button 480.

In response to clicking the button 470, the ESP 140 may send the email testing task to the system 200 for crowdsourcing an email testing task. In response to receiving the email testing task, the system 200 for crowdsourcing an email testing task may display a task field 485 to the customer. The customer may be requested to enter additional information associated with the email testing task to the task field 485, such as a task name, a task type, types of errors to be checked, browsers to be checked, compatible devices to be checked, rewards for performing the email testing task, task content, and so forth.

Upon receiving the additional information associated with the email testing task, the system 200 for crowdsourcing an email testing task may provide the email testing task to the crowdsourcing platform 440. The contractors registered with the crowdsourcing platform 440 may review the email content, perform the email testing task, test the email content, validate the performed email testing task, provide feedback, and so forth. The contractors may review the email content using a web interface, a mobile application, an application programming interface, an email, and so forth

The system 200 for crowdsourcing an email testing task may provide results 490 of performing the email testing task to the contractors for preview. The results 490 may be provided to the contractors for preview via a web interface, a mobile application, an application programming interface, an email, and so forth.

The system 200 for crowdsourcing an email testing task may provide results 495 of performing the email testing task to the customer. The results 495 may be delivered through various means including a user interface of the system 200 for crowdsourcing an email testing task, a browser extension, a mobile application, an application programming interface, an email, via the ESP, and so forth.

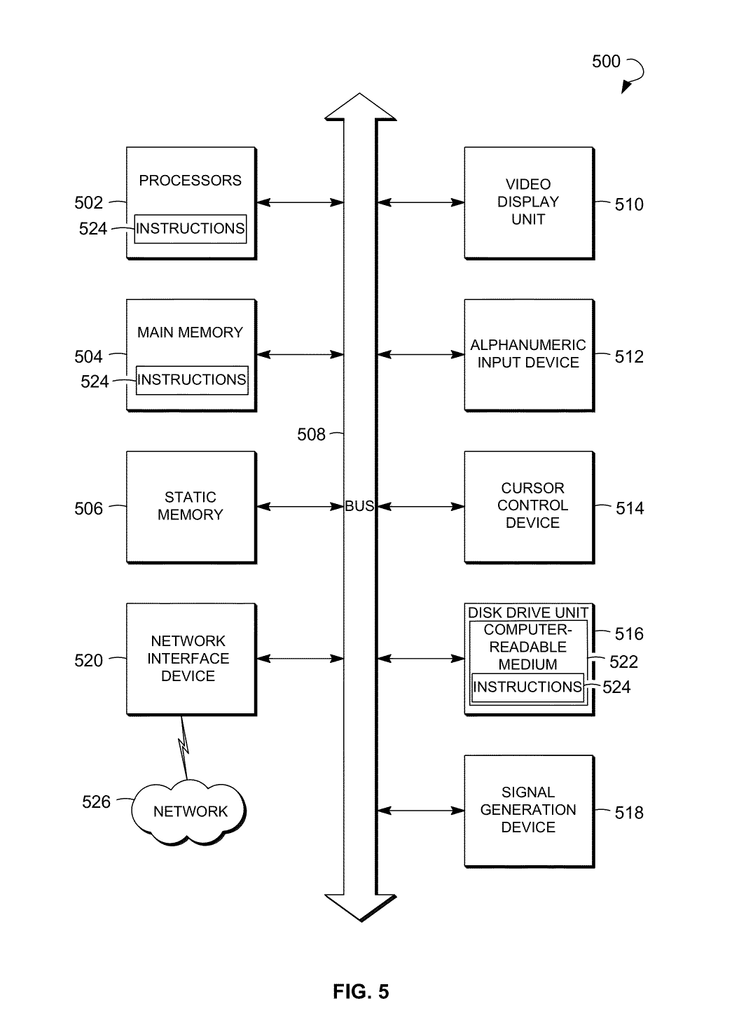

FIG. 5 shows a diagrammatic representation of a computing device for a machine in the exemplary electronic form of a computer system 500, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box (STB), a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 502, a hard disk drive 504, a main memory 506, and a static memory 508, which communicate with each other via a bus 510. The computer system 500 may also include a network interface device 512. The hard disk drive 504 may include a computer-readable medium 520, which stores one or more sets of instructions 522 embodying or utilized by any one or more of the methodologies or functions described herein. The instructions 522 can also reside, completely or at least partially, within the main memory 506 and/or within the processors 502 during execution thereof by the computer system 500. The main memory 506 and the processors 502 also constitute machine-readable media.

While the computer-readable medium 520 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, C++, C# or other compilers, assemblers, interpreters or other computer languages or platforms.

Thus, various systems and methods for crowdsourcing an email testing task have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer-implemented method for crowdsourcing an email testing task, the method comprising:
receiving, by a processor, the email testing task from a customer, the email testing task including at least an email content;
providing, by the processor, the email testing task to a crowdsourcing community;
receiving, by the processor, results of performing the email testing task from the crowdsourcing community; and
providing, by the processor, the results of performing the email testing task to the customer.

2. The method of claim 1, further comprising:
advertising, by the processor, the email testing task to the crowdsourcing community; and
assigning the email testing task to a contractor associated with the crowdsourcing community, wherein the email testing task is assigned based on predetermined criteria or a self-selection of the contractor,
wherein the providing of the email testing task to the crowdsourcing community includes providing the email testing task to the contractor.

3. The method of claim 2, wherein the contractor submits results of performing the email testing task.

4. The method of claim 1, wherein the email testing task further includes a task description.

5. The method of claim 1, wherein the email testing task is received from the customer via one or more of: an email service provider (ESP), a third-party application associated with the customer, and a user device associated with the customer.

6. The method of claim 5, wherein the ESP includes a crowd connector, the crowd connector being embedded in the ESP as one or more of the following: a native application, a browser extension, a code snippet, an application plug-in, an application add-in, a tag management system, and an embedding referential link.

7. The method of claim 6, wherein the providing of the email testing task to the crowdsourcing community includes connecting a contractor to the ESP via the crowd connector, wherein the email testing task is performed by the contractor remotely.

8. The method of claim 1, wherein the providing of the email testing task to the crowdsourcing community includes sending the email content associated with the email testing task to the crowdsourcing community.

9. The method of claim 1, wherein the email testing task includes one or more of: a typographical error checking task, a grammar checking task, a broken link checking task, a broken image checking task, an incorrect information checking task, a display checking task, and an opinion and feedback task.

10. The method of claim 1, wherein the results of performing the email testing task are provided to the customer via one or more of a web-based dashboard, a mobile application, an email, an application programming interface, and an export to a predetermined format.

11. A system for crowdsourcing an email testing task, the system comprising:
a processor configured to:
receive the email testing task from a customer, the email testing task including at least an email content;
provide the email testing task to a crowdsourcing community;
receive results of performing the email testing task from the crowdsourcing community; and
provide the results of performing the email testing task to the customer; and
a database communicatively coupled to the processor and configured to store at least the email testing task, the email content, and credentials associated with the crowdsourcing community.

12. The system of claim 11, wherein the processor further configured to:
advertise the email testing task to the crowdsourcing community; and
assign the email testing task to a contractor associated with the crowdsourcing community, wherein the email testing task is assigned based on predetermined criteria or a self-selection of the contractor,
wherein the providing of the email testing task to the crowdsourcing community includes providing the email testing task to the contractor.

13. The system of claim 12, wherein the contractor submits results of performing the email testing task.

14. The system of claim 11, wherein the email testing task further includes a task description.

15. The system of claim 11, wherein the email testing task is provided from the customer via one or more of: an ESP, a third-party application associated with the customer, and a user device associated with the customer.

16. The system of claim 15, wherein the ESP includes a crowd connector, the crowd connector being embedded in the ESP as one or more of the following: a native application, a browser extension, a code snippet, an application plug-in, an application add-in, through a tag management system, and an embedding referential link.

17. The system of claim 16, wherein the providing of the email testing task to the crowdsourcing community includes connecting a contractor to the ESP via the crowd connector, wherein the email testing task is performed by the contractor remotely.

18. The system of claim 11, wherein the providing of the email testing task to the crowdsourcing community includes sending the email content associated with the email testing task to the crowdsourcing community.

19. The system of claim 11, wherein the processor is further configured to:
receive, from the customer associated with the email testing task, a confirmation of completion of the email testing task by a contractor; and
based on the confirmation, manage payments associated with the email testing task.

20. A non-transitory computer-readable medium comprising instructions, which when executed by one or more processors, perform the following operations:
receive the email testing task from a customer, the email testing task including at least an email content;
provide the email testing task to a crowdsourcing community;
receive results of performing the email testing task from the crowdsourcing community; and
provide the results of performing the email testing task to the customer.
